(19) United States
(12) Patent Application Publication
(10) Pub. No.: US 2015/0085872 A1
(43) Pub. Date: Mar. 26, 2015

(54) SYSTEM FOR DYNAMIC CONTACT CENTER ROUTING

(71) Applicant: Cisco Technology, Inc., San Jose, CA (US)

(72) Inventors: Vipin Palawat, Boxborough, MA (US); Manish Shah, Boxborough, MA (US); Ankit Nitin, Boxborough, MA (US)

(73) Assignee: Cisco Technology, Inc., San Jose, CA (US)

(21) Appl. No.: 14/037,256

(22) Filed: Sep. 25, 2013

(51) Int. Cl. H04L 12/725; H04L 12/717

(52) U.S. Cl. CPC H04L 45/30; H04L 45/42
USPC 370/422

(57) ABSTRACT

A communication request from a contact center caller may be received in a contact center via any of a variety of communication devices equipped with any of a variety of operating systems, any of a variety of applications and with any of a variety of device capabilities. The communication request may also be received via any of the multiple different communication mediums. The contact center may have multiple agent devices logged in to the contact center. Agent devices logged in to the contact center may have different device capabilities. A system for dynamic contact center routing may route the communication request to an agent device based on device capabilities of a communication device used by the caller, and device capabilities of the agent device.

### FIELD

The present disclosure relates to communication request routing and more specifically, to routing communications within a contact center.

### BACKGROUND

Contact center callers could place a communication request with a contact center via a variety of communication devices equipped with a variety of operating systems and applications. The communication request may also be received via any of multiple communication mediums available today. The contact center may have multiple agent devices capable of receiving such communication requests.

### BRIEF DESCRIPTION OF THE DRAWINGS

FIG. 1 is a block diagram of an example system for dynamic contact center routing of a communication request.

FIG. 2 is an example contact center.

FIG. 3 is a set of steps followed by an example system for dynamic contact center routing of a communication request.

FIG. 4 is a set of steps followed by an example system for dynamic contact center routing of a communication request.

FIG. 5 is a block diagram of an example system for dynamic contact center routing of a communication request.

FIG. 6 is a set of steps followed by an example system for dynamic contact center routing of a communication request.

### DESCRIPTION OF EXAMPLE EMBODIMENTS

### Overview

By way of introduction, the example embodiments described below include a device and method to provide dynamic routing of a communication request, such as a communication request associated with a contact center.

According to a first aspect, a contact center device may include an interface to receive a communication request and a processor to determine communication device capabilities of a communication device from which the communication request is received. The processor may select a matching agent device for the communication request based on comparison of the communication device capabilities with agent device capabilities of multiple active agent devices. The processor may also forward the communication request to the matching agent device and setup a communication between the communication device and the matching agent device via communication medium compatible with the communication device and the matching agent device.

In a second aspect, a method to route a call to a contact center may initially identify calling device capabilities of a calling device and compare the calling device capabilities with agent device capabilities of various agent devices. The method may further include steps to determine a matching agent device from the various agent devices based on the comparison of the calling device capabilities and matching agent device capabilities and accordingly, route the call from the calling device to the matching agent device.

In a third aspect, a non-transitory computer readable media may store instructions executable by a processor. The computer readable media may include instructions to queue a communication request from a communication device, wherein the communication request is received via a first communication medium. Further, the instructions may determine device capabilities of the communication device according to the communication request and select a matching agent device from a plurality of active agent devices by comparison of the device capabilities with agent device capabilities of the active agent devices. The instructions may also establish communication between the communication device and the matching agent device via the first communication medium or via a second communication medium determined from the communication request.

Further aspects and advantages are discussed below in conjunction with the example embodiments.

### EXAMPLE EMBODIMENTS

It is to be understood that the following description of examples of implementations are given only for the purpose of illustration and are not to be taken in a limiting sense. The partitioning of examples in function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. Alternatively, or in addition, one or more functional blocks or units may also be implemented in a common circuit, chip, circuit element or unit.

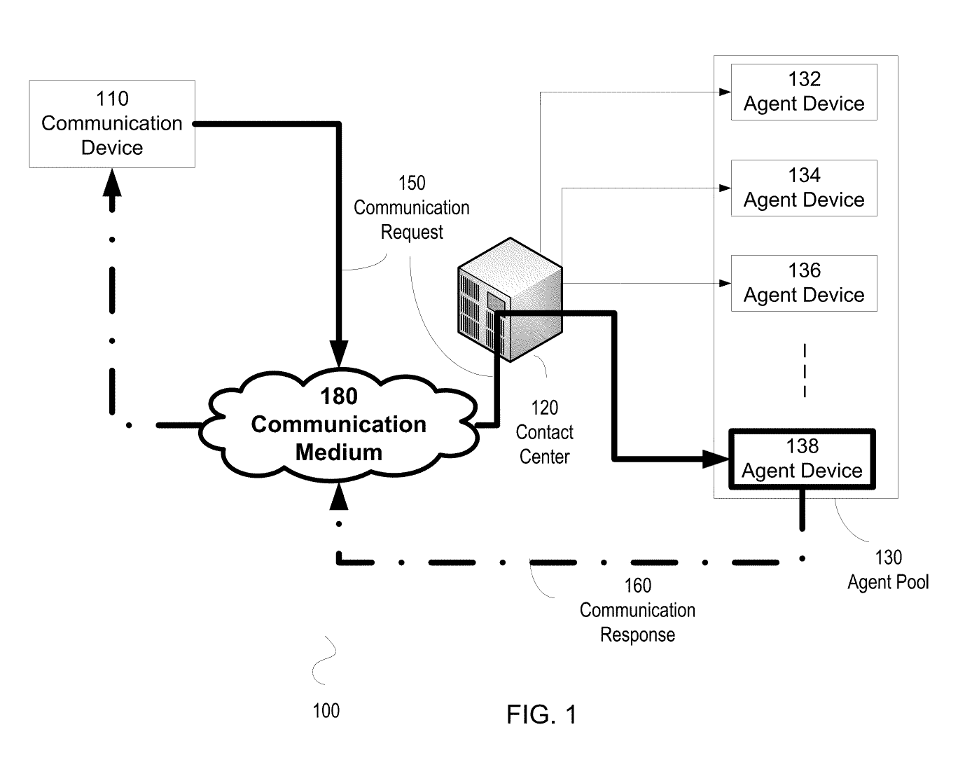

FIG. 1 is a block diagram of an example system 100 for dynamic contact center routing in communication with a communication device 110 via a communication medium 180. The system 100 may include a contact center 120, and an agent pool 130, configured to process a communication request 150 and send a communication response 180. The system 100 may include other components which are not shown in FIG. 1, such as but not limited to switches, routers, cell towers and other components to send and receive data for communication. In addition, any number of communication devices 110 may communicate with the system 100.

The communication device 110 may be a device that sends the communication request 150 to the contact center 120. The communication device 110 may be a wired telephone unit, a mobile phone, a smartphone, a softphone, a desktop computer, a tablet computer, a personal digital assistant device, a gaming console, a media player, a telepresence room, or any other device capable of communication via a wired or a wireless medium. The communication device 110 may also be a kiosk such as an Automated Teller Machine (ATM) or a medical kiosk with various medical instruments to gather patient diagnostic information. The communication device 110 may also be running any of a variety of operating systems and related applications such as Microsoft Windows, Apple OS X, Android, Linux, UNIX or any other operating system. The communication device 110 may send the communication request 150 by, for example, placing a call to the contact center 120. In other examples, any other form or format of request message in audible and/or visual form may be communicated to the call center 120. Whatever the form or format of the request message, the communication device 110 may be referred to as a calling device. The communication device 110 may leave the communication request 150 at the contact center 120 in form of, for example, a voice message. The call may be a public switched telephone network (PSTN) call or a voice over internet protocol (VoIP) call, or any other type of audio call. Alternately, the communication device 110 may send the communication request 150 via a visual format, such as a text message using a short messaging service or via an instant messaging service or via email. In another example system 100, the communication device 110 may transmit the communication request 150 via a media post such as a social media post on Facebook®, Twitter® or any other media service. The communication request 150 may be interpreted from content of the media post even if the media post may not be directed to the contact center 120.

The agent pool 130 includes one or more agent devices such as agent devices 132, 134, 136, and 138. An agent device, such as the agent device 132, may be logged in to the data center 120 and thereby be an active agent device. The log in process may involve entering login credentials, such as a username, password or other identification details of an agent logging in via the agent device 132. Once the agent device 132 is logged in or active, the agent device 132 may be available for selection by the contact center 120 to respond to the communication request 150.

The agent devices 132-138 and the communication device 110 may each have a set of device capabilities. The device capabilities, such as agent device capabilities and communication device capabilities, may include device settings, abilities based on connected peripherals, and capabilities to communicate via communication medium 180. The device settings may, for example, include settings such as screen resolution, microphone settings, and browser settings. For example, the device capabilities may include an ability to make audio or voice calls, video calls and conference calls which may or may not include video sharing. The device capabilities may further include, for example, sending and receiving messages, such as text messages and sending and receiving instant messages, sending and receiving media posts, such as social media posts, sharing screens and receiving screen-shares. The device capabilities may also include, for example, touch screen capability, near field communication capability, orientation capability, multi-screen capability, magnetic card reading capability, quick response (QR) code reading capability, location detection capability, scanning capability, and printing capability. The device capabilities may further include language related provisions such as typing in multiple languages like English, Japanese, Chinese, and Russian. The agent device capabilities may also include controlling aspects of the communication device 110. For instance, the agent device 132 in communication with the communication device 110 may log in to and/or change settings at the communication device 110. The agent devices 132-138 may have substantially identical agent device capabilities. Alternately, the agent devices 132-138 may have different agent device capabilities. For instance, the agent device 132 may have the agent device capabilities to make and receive an audio call while the agent device 138 may have the agent device capabilities to make and receive the audio call as well as make and receive a video call.

The agent device 132 may further be attributed with skills of the agent logged in via the agent devices 132. Agent skills may include technical knowledge such as knowledge about a particular product or technology. Agent skills may also indicate proficiency of the agent with the particular product or technology. The agent skills may also include languages spoken by the agent, customer service rating, seniority, efficiency rating and other skill related attributes that may be used to match the agent with a user requesting communication via the communication device 110. The agent skills may be independent of the agent device 132 and the agent device capabilities of the agent device 132 being used by the agent. The agent skills may remain unchanged irrespective of what agent device is being used by the agent. If the agent logs out from the agent device 132 and instead logs in from another agent device, the agent skills may be attributed to the other agent device the agent logs in to.

Further yet, if the communication device 110 has specialized peripherals that may be controlled by an operator, the agent device capabilities, may allow such control. For example, if the communication device 110 has peripherals to gather patient diagnostic information with medical instruments such as thermometers, heart-rate monitor, blood pressure monitor or any other such instrument, the agent device 132 may have the agent device capabilities to control such instruments and gather the patient diagnostic information. The peripherals may also include video cameras with orientation adjustment capability, such as pan and tilt capability. In another example, if the communication device 110 is capable of gathering and sending diagnostic information about the communication device 110, the agent device 132 may be capable to connect with the communication device 110 and receive the diagnostic information.

The agent devices 132-138 may be at a common geographic address or location. Alternately, the agent devices 132-138 may each be at separate geographic addresses. In another example, some of the agent devices may be at the common geographic address while others are at separate geographic addresses. The contact center 120 may be zero or more network hops away from any of the agent devices 132-138. The agent devices 132-138 may be devices of choice of respective agents.

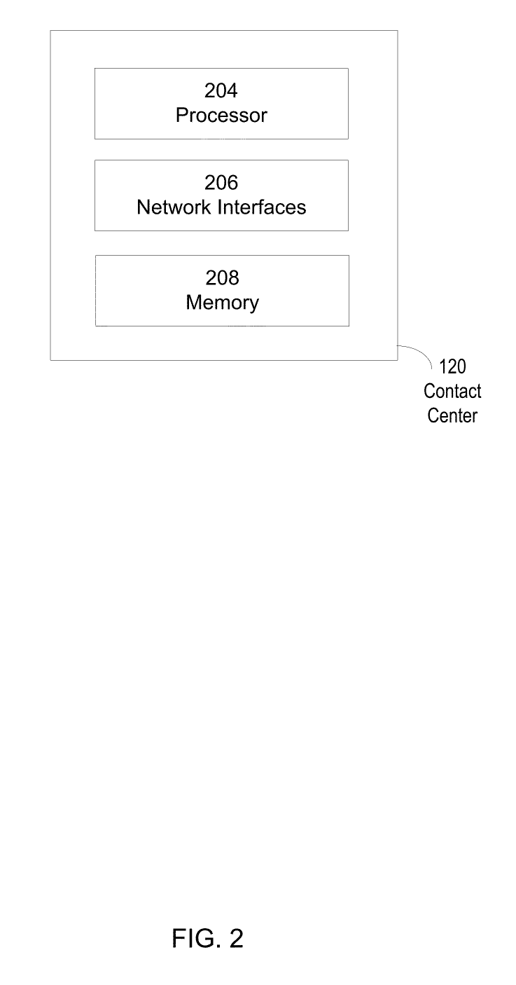

The contact center 120 may receive the communication request 150 from the communication device 110. The contact center 120 may be a device, as shown in FIG. 2, including a processor 204, one or more network interfaces 206 and a memory storage device 208. The processor may be a microprocessor, a digital signal processor, a graphics processing unit, or any other device capable of executing computer readable instructions. Alternately, the contact center 120 may be a collection of such devices operating as a single server by communicating instructions and data among each other.

The network interfaces 206 may enable communication between the communication device 110 and one of the agent devices in the agent pool 130. A network interface of the network interfaces 206 may be capable of receiving and transmitting data in the communication request 150 and the communication response 160 over a network. The network interface may include an embedded component as part of a circuit board, a computer mother board, a router, an expansion card, a printer interface, a USB (universal serial bus) device, or as part of any other hardware. The communication may be via a wired or a wireless communication medium 180. The communication medium 180 may utilize any protocol of 3G/4G/EDGE/4G LTE, Bluetooth®, WiMax®, GPRS, UMTS, HSDPA, HSPA or any other protocol or any combination thereof. The network interface may be capable of switching between one communication medium and another communication medium seamlessly without interruption in communication.

The memory 208 may be a non-transitory memory storage device and may include instructions executable by the processor 204 or the other units of the contact center 120. The memory 208 may be volatile memory and/or non-volatile memory or a cache memory such as a random access memory (RAM), or flash memory. Alternatively or in addition, the memory 208 may include an optical, magnetic (hard-drive) or any other form of data storage device. The memory 208 may store data related to the operation of the contact center 120. Such data may include capabilities of agent devices in the agent pool 130, attributes of the agent devices in the agent pool 130, the communication device capabilities, the agent device capabilities, agent login information, agent skill information, and scheduled callback requests among other data. The scheduled callback request, as described further, may be a request from the user of the communication device 110 containing information to be contacted with the communication response 160 at a scheduled time and/or scheduled device.

The contact center 120, with the processor 204, may determine the device capabilities of the communication device 110 as part of information included in the communication request 150. The communication request 150 may involve computer telephony integration protocols such as Java Telephony Application Programming Interface (JTAPI), Telephony Server Application Programming Interface (TSAPI), Telephony Application Programming Interface (TAPI) or any other session initiation protocol (SIP), in which case the contact center 120 may determine the communication device capabilities via the SIP headers. Alternately, if the communication request 150 is a social media post, the communication device capabilities may be extracted from information appended to the social media post by the communication device 110 when the social media post is being uploaded. The contact center 120 may check social media application fields, source code and other parameters to determine identity of the communication device 110 and/or the device capabilities of the communication device 110. The contact center 120 may route the social media post to the agent device 132 equipped with agent device capabilities that may optimally leverage the device capabilities of the communication device 110. Optimal leverage of the device capabilities may include using all of the device capabilities. Alternately, optimal leverage of the device capabilities may involve using a partial set of the device capabilities that a user of the communication device 110 desires to use. Alternately, the partial set of the device capabilities may be the device capabilities required to respond and solve a query posed by the communication request 150. In another example, if the communication request 150 is an instant messaging request such as a chat request, the communication request 150 may involve a secure or non-secure hypertext transfer protocol (HTTPS or HTTP, respectively) which may include information regarding the device capabilities of the communication device 110. In yet another example, the communication request 150 may include the device capabilities of the communication device 110.

Similarly, the contact center 120, may determine the agent device capabilities of the multiple agent devices 132-138. The contact center 120 may determine the agent device capabilities of the agent device 132 while the agent device 132 is logging in to the contact center 120, or following log in. The contact center 120 may thus dynamically determine agent capabilities of an agent logging in via the agent device 132. The agent capabilities may include the agent device capabilities of the agent device 132 used by the agent at that time and the agent skills. Since an agent may log in to the contact center 120 via different agent devices, the contact center 120 may dynamically determine the agent device capabilities, and thus the agent capabilities on or following every log in. Alternately, the contact center 120 may store the agent device capabilities of a particular agent device and access the stored agent device capabilities in response to identification of the particular agent device used for logging in at a later time. In another example, the contact center 120 may classify certain agent devices as part of a group based on agent device capabilities. For example, the contact center 120 may classify the agent devices 132 and 134 as a video calling group based on the agent devices 132 and 134 being capable to send and receive a video call. The video calling group may be dynamically changed as agent devices with video calling capability log in to (or log out from) the contact center 120.

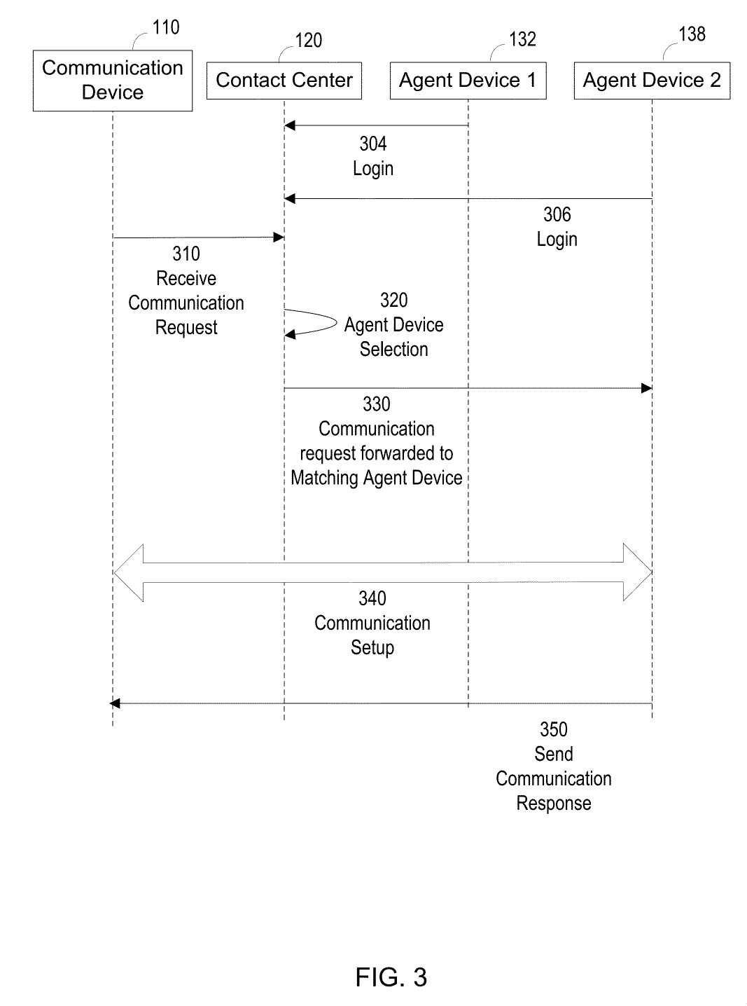

The contact center 120 may select one of the agent devices from the agent pool 130 to respond to the communication request 150. For example, the contact center 120 may select the agent device 138 (shown in bold in FIG. 1) to send the communication response 160 in response to the communication request 150. FIG. 3 is an example sequence of steps that may be followed by the system 100. The agent devices 132 and 138 may login to the contact center 120 as depicted in steps 304 and 306. The communication request 150 may be received by the contact center 120 in step 310. The contact center 120 in step 320 may perform an agent device selection.

The agent device selection may be based on the device capabilities of the communication device 110. The agent device selection may also be based on the agent device capabilities of the active agent devices. The contact center 120 may compare the device capabilities of the communication device 110 with the agent device capabilities of the active agent devices 132-138. Based on the comparison, the contact center 120 may identify or select a matching agent device 138 to respond to the communication request 150. The contact center 120 may look for an available, or soon to be available, agent device with agent device capabilities that most closely match or are substantially similar to the communication device capabilities. An agent device capability may be said to match a communication device capability if the corresponding agent device may be compatible with to support or use the communication device capability. For example, if the contact center 120 determines that the device capabilities of the communication device 110 include audio and video call capabilities, the agent device, such as the agent device 138 with the agent device capabilities of sending/receiving audio and video call may be selected as the matching agent device. In another example, if the communication device is capable of high resolution display, the selected matching agent device 138 may be compatible with and capable of using the high resolution display. The agent device capability may or may not be identical to the communication device capability. The agent device capability may be analogous to or comparable to the communication device capability. For example, the communication device 110 may execute a previous operating system version while the selected matching agent device 138 may execute a later version of the operating system or a different operating system compatible with the operating system version of the communication device 110.

The agent device capabilities may be said to closely match the communication device capabilities if the agent device supports at least a predetermined number of the communication device capabilities. Alternatively or in addition, a rank or weightage may be allocated to each device capability. Based on the comparison of the communication device capabilities and the agent device capabilities, a cumulative weightage or a cumulative rank may be assigned to each of the agent devices 132-138. The cumulative rank or cumulative weightage of an agent device may signify how closely the agent device matches the communication device 110. The cumulative rank or cumulative weightage of the matching agent device 138 may be based on the respective weightage or rank of device capabilities that match between the communication device 110 and the matching agent device 138. Further, the matching agent device 138 may have the best cumulative weightage or cumulative rank among the agent devices 132-138. The selection of the agent device 138 may allow the agent device 138 to take full advantage of the device capabilities of the communication device 110.

In the event, there is a subset of agent devices with matching agent device capabilities, the contact center 120 may further compare the skills attributed to each of the agent device in the subset of agent devices with content or classification of the communication request 150. For example, if the communication request 150 is regarding particular product, the matching agent device 138 may be selected based on the skills attributed to the matching agent device including expertise of the particular product. In another example, the communication request 150 may be classified as regarding a particular technology based on parameters received from the communication device 110. The agent skills of the agent logged in via the matching agent device 138 may include knowledge of the particular technology. The contact center 120, may give each of the agent devices 132-138 a rating that may indicate a match quality of the agent devices 132-138 and the communication device 110. The contact center 120 may then select the matching agent device 138 based on the rating of the agent device 138 being the best, such as the highest or lowest rating, among the available ratings. The contact center 120 may store the ratings corresponding to the communication device 110 for future communication requests from the communication device 110.

Once the matching agent device 138 is selected, the contact center 120, in step 330, may forward the communication request 150 to the matching agent device 138. The agent device 138 and the communication device 110 may establish a communication link in step 340 and proceed to step 350 in which the agent device 138 provides the communication response 160 to the communication device 110. Alternately, in step 340, the contact center 120 may establish the communication link between the matching agent device 138 and the communication device 110. The establishment of the communication link may involve, for example, handshaking for one or more particular communication mediums or interfaces available for communication between the matching agent device 138 and the communication device 110. Establishing the communication link may further include setting up screen resolution of the matching agent device 138 to reflect a screen resolution of the communication device 110. The establishment of the communication link may also involve routing the matching agent device 138 or the contact center 120 to execute certain procedure scripts based on the communication device capabilities. For example, if the communication device 110 is touch screen enabled, the matching agent device 138 may use a touch interface instead of using a traditional dual-tone multi-frequency (DTMF) tone based interface. Alternately, or in addition, establishing the communication link may involve establishing a connection with peripherals, such as a printer, credit card reader, heart rate monitor, video camera and other peripherals which may be used during the communication. Establishing the communication link in step 340 may depend on a context of the communication request 150. For example, if the communication request 150 involves a banking transaction, establishing the communication link may involve setting up a connection with a credit card reader or other devices used in the banking transaction. Instead, if the communication request 150 involves a health care related communication, connection(s) with a heart rate monitor, thermometer, blood pressure monitor, or other such diagnostic peripherals would be set up.

In an example system 100, the matching agent device 138 may have agent device capabilities that exceed the device capabilities of the communication device 110. In such a case, excess agent device capabilities may be disabled so that the matching agent device 138 functions as closely with the communication device 110 as possible. For example, if the matching agent device 138 has dual monitors but the communication device 110 only has a single monitor, the matching agent device 138 may be switched to use a single monitor configuration.

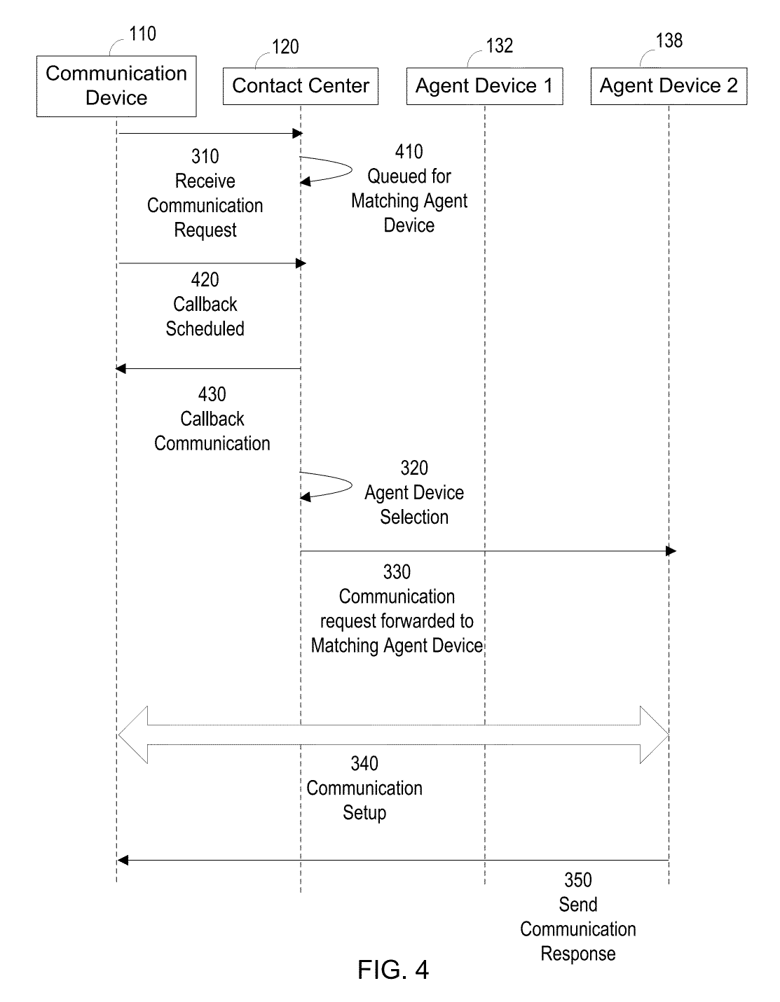

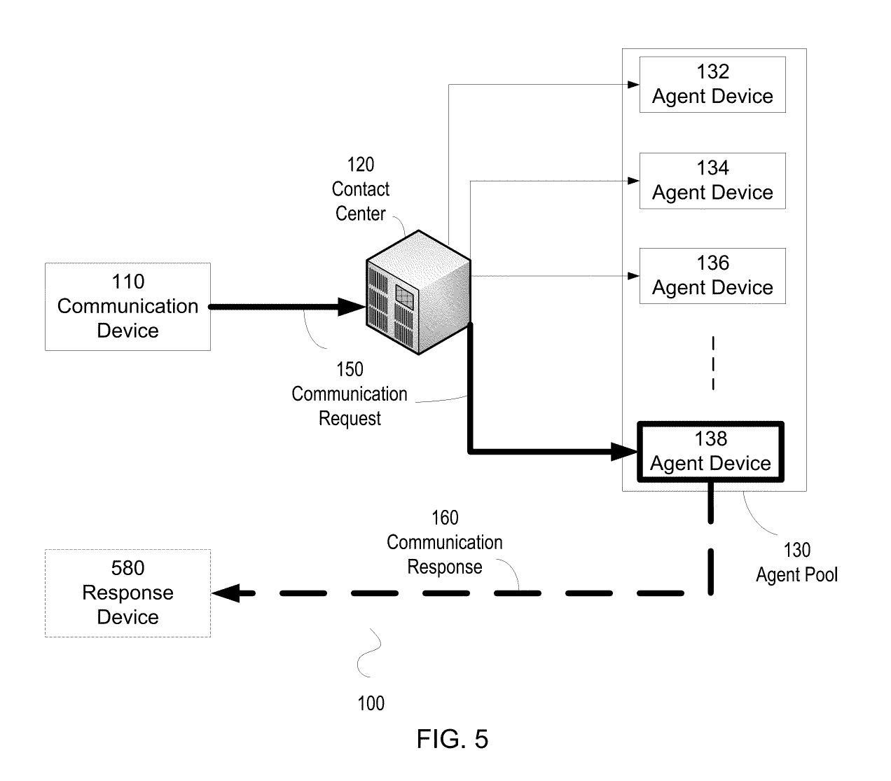

In case the communication request 150 is a telephone call, for example, in step 330 the contact center 120 may route the telephone call to the matching agent device 138. Alternately, if the communication request 150 is an instant messaging request, for example, step 330 may involve the contact center 120 forwarding the instant messaging request to the matching agent device 138. During the agent selection step 320, the communication device 110 may be queued for the matching agent device 138 as shown in step 410 of FIG. 4. While in in a queue, the communication device 110 may schedule a callback in step 420 via a callback scheduling request. The callback scheduling request may include a time to receive the communication response 160 at the communication device 110. At the scheduled callback time, the contact center 120 may send a callback communication to the communication device 110 and the matching agent device 138. The contact center 120 may have selected the matching agent device 138 before the scheduled callback time or may perform the agent selection step 320 at the scheduled callback time. Alternately, or in addition, the scheduled callback of step 420 may include a request to send the communication response 160 to a response device 580. In such a scenario, as shown in FIG. 5, the selected agent device 138 may send the communication response to the response device 580 instead of the communication device 110. The response device 580 may be the communication device 110 itself or may be a telecommunication device that is of the same type, and thus same device capabilities as that of the communication device 110. Alternately, the response device 580 may have different device capabilities than the communication device capabilities. The contact center 120 may receive the device capabilities of the response device 580 from the communication request 150 or the scheduled callback of step 420. Alternately, the contact center 120 may determine the device capabilities of the response device 580 during transmission of the callback communication in step 430. In this case, the contact center 120 may perform the agent device selection step 320 after the callback communication step 430.

The contact center 120, in the above example, may perform the agent selection step 320 at least twice. The contact center 120 may have already selected the matching agent device 138 before the scheduled callback is requested in step 420. The contact center 120 may store identity of the matching agent device 138 along with the scheduled callback. At the scheduled callback time the contact center 120 may access the stored identity to forward the communication request 150 to the matching agent device 138. Alternately, the contact center 120 may re-run the agent selection at the scheduled callback time and identify another matching agent device, such as the agent device 134 to send the communication response 160.

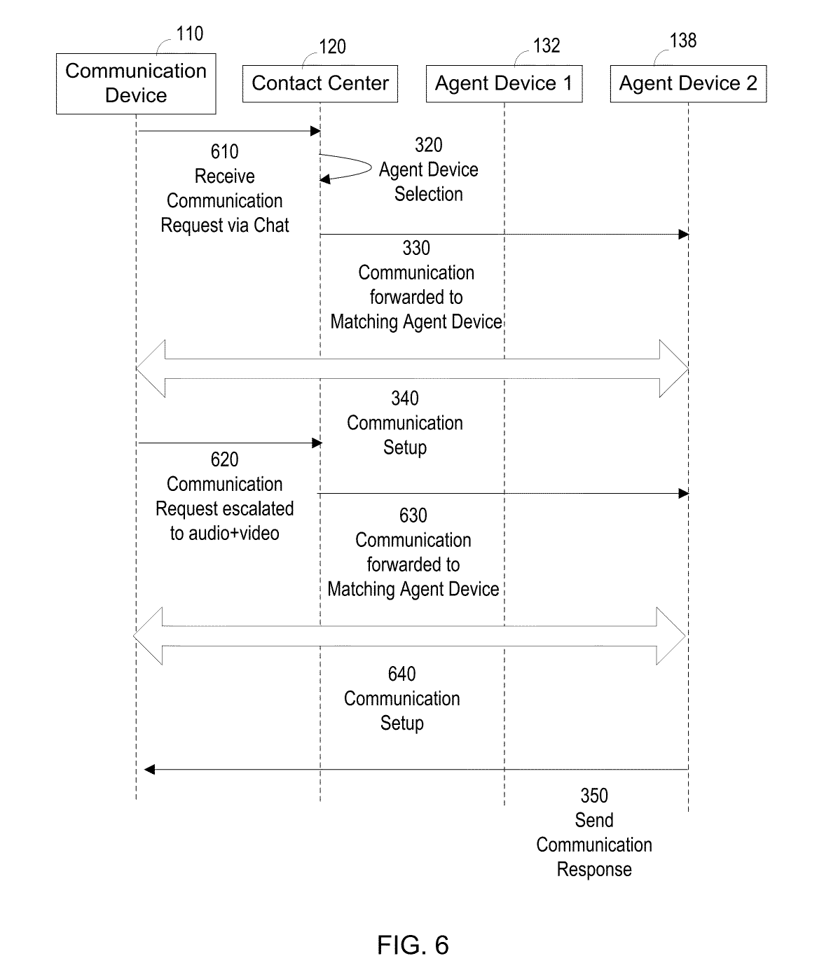

In yet another example, depicted in FIG. 6, the communication device 110 may escalate the communication request 150 from one communication medium to another. The escalation may involve a communication request via another communication medium that may be more or less feature rich than a first communication medium. The communication medium requested by the escalation may use more or less communication bandwidth than the first communication medium. For example, as shown in FIG. 6, the communication request 150 may be received via the instant messaging medium in step 610. The communication request 150 may be escalated at the communication device 110 to use audio and video medium. The contact center 120 may forward the escalated communication request to the matching agent device 138 in step 630. Irrespective of when the escalation occurs, the contact center 120 may perform an agent selection step 320 and determine the matching agent device 138 based on the device capabilities of the communication device 110 and the agent device capabilities. The matching agent device 138 would therefore have the agent device capabilities to communicate via the escalated communication medium, in this case the audio and video medium. Thus, even if the communication request 150 is escalated to the audio and video medium, the matching agent device 138 would be capable to handle the communication request and provide the necessary communication response 160 using the escalated communication medium. If the matching agent device 138 had already initiated the communication setup process with the communication device 110 in response to the instant messaging communication request from step 310, the communication setup is retracted and another communication setup is performed in step 640 for the escalated audio and video communication request. In another example, the communication request 150 may be received via audio and video and an escalation request may be to communicate via instant messaging.

The communication response 160 may be a message sent to the communication device 110 or the response device 580 in response to the communication request 150. The communication response 160 may use the communication medium 180 used by the communication request 150. Thus, if the communication request 150 uses the instant messaging service, the communication response 160 may be via instant messaging service as well. But, as described earlier, the communication request 150 may choose to have the communication response 160 to be sent via a different communication medium. For example, the communication request 150 may be via email opting to receive the communication response 160 as a telephone call. Alternately, the communication request 150 may be a social media post and the communication response 160 may be via the instant messaging service. Such choice may also be part of the scheduled callback request. Further, selection of the matching agent device 138 may be limited by the contact center 120 to communication device 110 that satisfies certain conditions, such as being member of a privileged class of clients. For example, if the communication request 150 is received from a client in the privileged class of clients, the contact center 120 may perform the agent selection step. The contact center 120 may skip the agent selection step and route the communication request 150 from a client outside the privileged class of clients to the next available agent device 132-138.

Various embodiments described herein can be used alone or in combination with one another. The foregoing detailed description has described only a few of the many possible implementations of the present disclosure. For this reason, this description of example embodiments is intended by way of illustration, and not by way of limitation.

We claim:

1. A device comprising:
an interface configured to receive a communication request from a communication device;
a processor configured to determine communication device capabilities of the communication device based on the communication request;
the processor further configured to select a matching agent device from among a plurality of active agent devices based on comparison of the determined communication device capabilities with agent device capabilities of the plurality of active agent devices;
the processor further configured to forward the received communication request to the selected matching agent device; and
the processor further configured to set up a communication link between the communication device and the selected matching agent device.

2. The device of claim 1, wherein the processor is configured to select the matching agent device before the communication link between the communication device and the matching agent device is set up.

3. The device of claim 1, further comprising:
a memory configured to store the communication device capabilities of the communication device;
the memory further configured to store a scheduled callback request from the communication device, wherein the scheduled callback request indicates a scheduled time; and
the processor further configured to schedule the matching agent device to communicate over the communication link with the communication device at the scheduled time.

4. The device of claim 1, wherein the communication device is a first communication device, the communication device capabilities is a first communication device capabilities, and the matching agent device is a first matching agent device, the device further comprising:
a memory configured to store a scheduled callback request from the first communication device, wherein the scheduled callback request indicates a scheduled time and a second communication device to receive a scheduled callback;
the processor configured to initiate communication with the second communication device;
the processor further configured to determine second communication device capabilities of the second communication device based on the communication with the second communication device; and
the processor further configured select a second matching agent device from among the plurality of active agent devices, the second matching agent device selected to receive the scheduled callback based on comparison of the second communication device capabilities with the agent device capabilities of the plurality of active agent devices;
the processor further configured to forward the scheduled callback to the second matching agent device; and
the processor further configured to establish a communication link between the second communication device and the selected second matching agent device.

5. The device of claim 1, wherein,
the processor is further configured to determine a subset of matching agent devices from the active agent devices based on the comparison of the communication device capabilities with agent device capabilities of the active agent devices;
the processor is further configured to select the matching agent device from the subset of matching agent devices based on comparison of content of the received communication request and skills attributed to each respective agent device within the subset of matching agent devices.

6. The device of claim 1, wherein agent device capabilities of the selected matching agent device exceed the communication device capabilities and the processor is configured to disable one or more of the agent device capabilities of the selected matching agent device during the communication between the communication device and the selected matching agent device.

7. The device of claim 1, wherein the communication request is at least one of a telephone call, a text message, an instant message, or a social media post.

8. The device of claim 1, wherein the processor is configured to determine the communication device capabilities from at least one of a header of the communication request or content of the communication request and the communication device capabilities comprise at least one of audio capability, video capability, instant messaging capability, screen sharing capability, touch screen capability, near field communication capability, orientation determination capability, multi-screen capability, or printing capability.

9. A method comprising:
identifying, at a processor, calling device capabilities of a calling device;
comparing, by the processor, the calling device capabilities and agent device capabilities of a plurality of agent devices;
determining, by the processor, a matching agent device from the agent devices based on the comparison of the calling device capabilities and agent device capabilities; and
routing, by the processor, a call from the calling device to the matching agent device.

10. The method of claim 9, further comprising:
receiving, at the processor, a classification of the call from the calling agent;
determining, by the processor, a subset of agent devices based on the comparison of the calling device capabilities and the agent device capabilities of each of the agent devices prior to determining the matching agent device;
determining, by the processor, the matching agent device from the subset of agent devices based on a comparison of the classification of the call with skills attributed to each agent device from the subset of agent devices.

11. The method of claim 9, wherein the calling device is a first calling device, the method further comprising:
scheduling, by the processor, a time to communicate with the first calling device in response to a communication request received from a second calling device; and
identifying, by the processor, the calling device capabilities of the first calling device during initiation of communication with the first calling device at the scheduled time.

12. The method of claim 9, wherein the calling device capabilities comprise audio capability, video capability, instant messaging capability, screen sharing capability, touch screen capability, near field communication capability, orientation capability, multi-screen capability, and printing capability.

13. The method of claim 9, further comprising the processor identifying a capability among the agent device capabilities of the matching agent device that exceeds the calling device capabilities.

14. The method of claim 13, further comprising disabling the identified capability based on the calling agent device capabilities.

15. A non-transitory computer readable media comprising instructions executable by a processor, the computer readable media comprising:
instructions to queue a communication request from a device, wherein the communication request is received via a first communication medium;
instructions to determine device capabilities of the device according to the communication request;
instructions to select a matching agent device from a plurality of active agent devices by comparison of the device capabilities with agent device capabilities of the active agent devices; and
instructions to establish communication between the device and the matching agent device via the first communication medium or via a second communication medium determined from the communication request.

16. The non-transitory computer readable media of claim 15, wherein a communication medium comprises at least one of a telephone call, an instant message, a video call, or a social media post.

17. The non-transitory computer readable media of claim 15, wherein the communication is a first communication, wherein the instructions further comprise:
instructions to request communication over a third communication medium; and
instructions to establish a second communication between the matching agent device and the device via the third communication medium.

18. The non-transitory computer readable media of claim 15, wherein the instructions to select the matching agent device from the plurality of active agent devices comprises comparison of content of the communication request with respective skills attributed to each respective agent device of the active agent devices, wherein the skills are identified based on login credentials received at each respective agent device.

19. The non-transitory computer readable media of claim 15, wherein the instructions to select the matching agent device are executed prior to execution of the instructions to establish the communication between the device and the matching agent device.

20. The non-transitory computer readable media of claim 15, further comprising:
instructions to store the device capabilities with a callback request in response to receipt of a callback scheduling request from the device; and
instructions to establish the communication between the device and the matching agent device at a scheduled callback time according to the callback request.
